(19) United States
(12) Patent Application Publication
(10) Pub. No.: US 2011/0293057 A1
(43) Pub. Date: Dec. 1, 2011

(54) APPARATUS FOR DETECTING NEUTRONS AND METHODS FOR FABRICATING SUCH APPARATUSES

(75) Inventors: Daniel Edward Bowen, III, Olathe, KS (US); Eric Allen Eastwood, Raymore, MO (US); Thomas Wayne Robison, Stiwell, KS (US)

(73) Assignee: HONEYWELL FEDERAL MANUFACTURING & TECHNOLOGIES LLC, Kansas City, MO (US)

(21) Appl. No.: 13/118,090

(22) Filed: May 27, 2011

Related U.S. Application Data
(60) Provisional application No. 61/348,792, filed on May 27, 2010.

(51) Int. Cl. G21G 1/06

(52) U.S. Cl. 376/159

(57) ABSTRACT

Apparatuses for detecting neutrons, and methods for fabricating such apparatuses, are provided. The neutron detection apparatus includes a cell configured to hold water. Further, the neutron detection apparatus provides a source of one or more high barns isotopes positioned in the cell and configured to absorb neutrons. Neutron absorption by the high barns isotope in the presence of water causes the formation of H₂O₂. Further, the presence of H₂O₂ in the cell indicates exposure of the cell to neutrons.

### PRIORITY CLAIM

This application claims priority to U.S. Provisional Application Ser. No. 61/348,792 entitled “METHODS AND SENSORS FOR DETECTING NEUTRONS” and filed on May 27, 2010. That application is incorporated herein by reference in its entirety.

### STATEMENT OF GOVERNMENT INTEREST

The U.S. Government has rights in this invention pursuant to contract number DE-NA0000622 with the United States Department of Energy.

### FIELD OF THE INVENTION

The present invention generally relates to apparatuses and methods for detecting nuclear material, and more particularly relates to apparatuses for detecting neutrons and methods for fabricating such apparatuses.

### BACKGROUND OF THE INVENTION

Despite increased security efforts to contain and monitor nuclear material, there exists the potential for the clandestine transportation or storage of unmonitored nuclear material. This threat is particularly evident in view of the mobility of so-called “dirty bombs”, which are considered to be conventional explosives combined with radioactive nuclides designed to spread radioactive contamination upon detonation. Further, other fissile material and neutron and radiation emitting sources can present a large threat to the public.

In recent years, gamma ray detectors have been utilized to detect radioactive isotopes that are essential for nuclear explosives. However, current technology presents a number of drawbacks. Often, such gamma ray detectors register false positives. For example, current sensors may identify high gamma-ray emitting sources such as food irradiators, medical and radiography sources, and medical patients as nuclear material. Further, systems used to detect nuclear material are often expensive and require close observation or operation.

Accordingly, it is desirable to provide an apparatus for detecting nuclear material that overcome these drawbacks. In addition, it is desirable to provide methods for fabricating such apparatuses. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Apparatuses for detecting neutrons and methods for fabricating such apparatuses are provided. In accordance with one embodiment, a neutron detecting apparatus comprises a cell configured to hold water. A source of a high barns isotope is positioned in the cell and configured to absorb neutrons. Neutron absorption by the high barns isotope in the presence of water causes the formation of H₂O₂. The presence of H₂O₂ in the cell indicates exposure of the cell to neutrons.

In accordance with another embodiment, a neutron detection apparatus has a non-exposed state and a neutron exposed state. The neutron detection apparatus in the non-exposed state comprises water and a source of a high barns isotope mixed with the water and configured to absorb neutrons. The apparatus is configured to transform to the neutron exposed state from the non-exposed state when the high barns isotope absorbs neutrons and H₂O₂ is formed.

A method for fabricating a neutron detection apparatus provides a cell configured to hold water, in accordance with an exemplary embodiment. The method comprises inserting a source of a high barns isotope configured to absorb neutrons into the cell. Neutron absorption by the high barns isotope in the presence of the water causes the formation of H₂O₂. The presence of H₂O₂ in the cell indicates exposure of the cell to neutrons.

### BRIEF DESCRIPTION OF THE DRAWINGS

The present invention will hereinafter be described in conjunction with the following drawing figures, wherein like numerals denote like elements, and wherein:

FIG. 1 is a perspective view of the implementation of neutron detecting apparatuses in accordance with an exemplary embodiment;

FIG. 2 is a cross sectional view of a neutron detecting apparatus in accordance with an exemplary embodiment; and

FIG. 3 is a cross sectional view of a neutron detecting apparatus in accordance with another exemplary embodiment

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Neutron detection apparatuses and methods for fabricating such neutron detection apparatuses are provided herein. The neutron detection capabilities of the apparatus can be utilized to record the presence or former presence of nuclear material. For instance, the apparatus can be placed in a shipping container to determine whether nuclear material has been shipped or stored therein. Because the apparatus does not require a power source or any kind of control circuitry, nor observation or operation, it is ideal for shipping and travel pinch points, such as ports, terminals and border crossings. In addition to monitoring shipping containers, the apparatus could be used in highly distributed applications, such as nuclear forensics, yield determination after a nuclear detonation, especially in an urban environment, and for documenting nuclear excursions, or sub-critical incidents.

In operation, the apparatus relies on neutron capture and the resulting formation of hydrogen peroxide (H₂O₂). Specifically, ionizing radiation associated with the neutron capture by, for example, 10B, 6Li, 157Gd, or 235U, in the presence of water produces H₂O₂ in an amount directly proportional to the Linear Energy Transfer (LET) or about 1×10⁴ (1E4) H₂O₂ per 1 megaelectron volt (MeV). Depending on the neutron target isotope, between 2E4 and 1.5E6 H₂O₂ molecules are produced per neutron capture event. Further, H₂O₂ molecules formed can build up within the apparatus and can remain unreacted for very long periods of time. For example, a small apparatus with an area of only 0.025 m² placed on a cargo container at a distance of about 2.5 meters from 50 kg of highly enriched uranium (HEU) could integrate well over 10E8 neutrons during a 12-day trans-Pacific crossing.

To capture neutrons, the apparatus comprises a source of a high barns isotope. Specifically, the absorption neutron cross-section of an isotope of a chemical element is the effective cross sectional area that an atom of that isotope presents to absorption, and is a measure of the probability of neutron capture. It is usually measured in barns (b). For the present apparatus, a high barns isotope, or an isotope having a high probability of neutron capture due to the large effective cross sectional area of its atom, is used so that even the presence of a small amount of neutron radiating material is detected.

In certain embodiments, the high barns isotope may be ¹⁰B, ⁶Li, ¹⁵⁷Gd, or ²³⁵U. When a ¹⁰B nucleus captures a thermal neutron, an a particle (⁴He) and ⁷Li ion are produced with a combined kinetic energy of about 2.31 MeV. When a ⁶Li nucleus captures a neutron, tritium (³H) and an a particle (⁴He) are produced releasing roughly double the amount of energy at about 4.8 MeV. In the case of gadolinium (¹⁵⁷Gd) and uranium (²³⁵U) neutron capture the situation is more complicated. With ¹⁵⁷Gd, ¹⁵⁸Gd is produced, as well as a complicated assortment of gamma and x-rays, and internal conversion, Auger, and Coster-Kronig (ACK) electrons, producing about 7.8 MeV of energy. All of the byproducts of this reaction have low linear energy transfer (LET), with the exception of the high-LET ACK electrons. On the order of 200 MeV of ionizing radiation is released when ²³⁵U captures a neutron, of which about 160 MeV of this energy is LET.

The number of hydrogen peroxide molecules produced via a neutron capture is known to be proportional to the amount of energy released from the in situ neutron capture event and has been measured to be about 1E4 molecules per MeV of ionizing radiation. Therefore, a single boron neutron capture event would produce over 2E4 hydrogen peroxide molecules. Furthermore, the high-LET alpha and lithium daughter particles have extremely short trajectories; 10 microns, or less. Therefore, the localized concentration of hydrogen peroxide will be quite high, even approaching milli-molar concentrations. Similarly, a single lithium neutron capture event would be estimated to produce less than 5E4 molecules. For the same thickness of material, one enriched with 50 weight percent (wt %) ¹⁰B and the other with ⁶Li, the first would yield about four times more neutron capture events than the other. However, the number of hydrogen peroxide molecules produced by the ¹⁰B enriched material is only about two times greater, because ⁶Li releases about two times more energy than does ¹⁰B. Therefore, with enriched materials boron is approximately twice as effective as lithium. Boron's advantage over lithium increases with natural abundances. In that case, the same thickness of 50 wt % lithium material would produce more than 20% fewer hydrogen peroxide molecules than the equivalent boron containing material. If the thickness of the detection system material is not critical, for example, because gamma rejection is adequately high, and a sufficiently thick film or amount can be used to capture incident neutrons, then ⁶Li has the advantage of introducing about 2.1 times more LET into the surrounding water, thus producing that much more H₂O₂ per neutron captured.

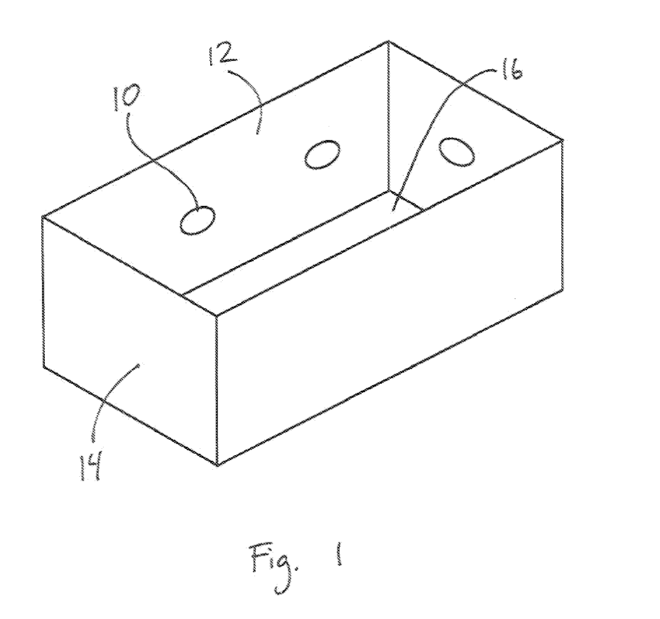

In accordance with an exemplary embodiment, FIG. 1 is a perspective view of a plurality of neutron detection apparatuses 10 in use. As shown, each neutron detection apparatus is positioned on an interior wall 12 of a shipping container 14. While illustrated as being applied to the walls 12, each apparatus 10 may be formed to fit in a crevice, corner or other inconspicuous location. Further, each apparatus may be formed as thin sheets or pliable bladders that may be rolled up for shipping and installed on a wall 12, floor 16, or ceiling (not shown). While each apparatus 10 is depicted as having an oval shape, any shape or form can be utilized for the purpose of detecting neutrons.

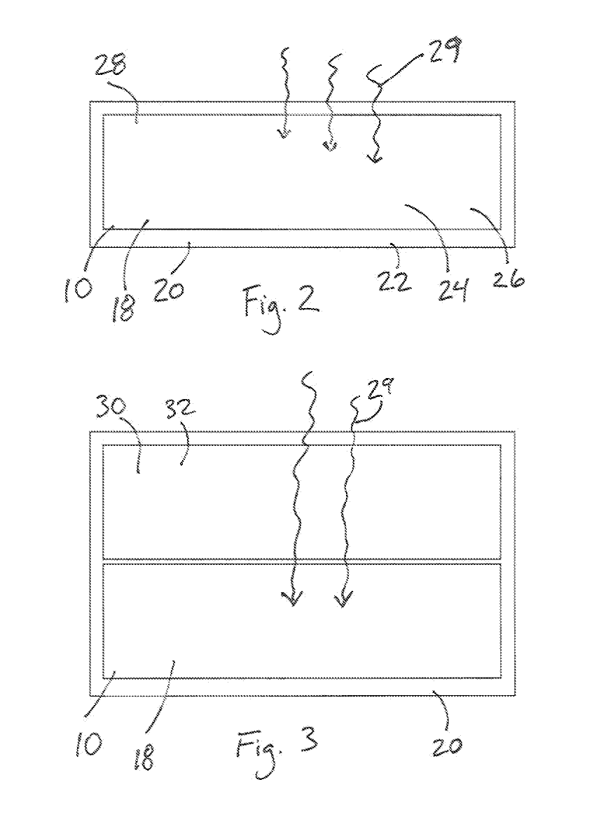

Referring now to FIG. 2, it can be seen that the apparatus 10 includes a cell 18 that is bound by an optional housing 20. Specifically, if the cell 18 is liquid, the housing 20 is utilized, however, the cell 18 may be a solid gel in which case the housing 20 may not be necessary. In FIG. 2, the housing 18 includes four distinct walls 22; however, the housing may be formed by a single curved wall, by two walls sealed together, or by other arrangements. For purposes of neutron detection, a source 24 of at least one high barns isotope is positioned in the cell 20. In certain embodiments, two or more different high barns isotopes may be provided by more than one source. In the exemplary embodiment, the source 24 is water soluble. In FIG. 2, water 26 is also positioned in the cell 20. Due to the water solubility of the source 24, the source 24 and the water 26 form a substantially homogenous mixture 28 within the cell 20. Depending on the selected sources 24 and high barns isotopes, an additional solvent or solvents may be provided in the cell 18 to allow for substantial homogeneity of the mixture.

During use of the apparatus 10 for neutron detection, neutrons, as indicated by arrows 29, pass into the internal space 20. When a neutron 29 contacts the high barns isotope, it is captured. As a result, hydrogen peroxide is formed from the water. With the high barns isotope, water, and hydrogen peroxide contained within the cell, record of the neutron capture is provided for later interrogation. Specifically, the selected interrogation of the cell will reveal the amount of hydrogen peroxide which, at a minimum, indicates the presence or former presence of neutrons, but may also be a direct indication of the amount of neutrons detected by the apparatus 10. Since hydrogen peroxide decomposes at a known, temperature dependent half life, the amount of hydrogen peroxide may not be a direct measure of the number of recorded neutrons.

Because gamma radiation can also cause the formation of hydrogen peroxide from water, FIG. 3 includes a reference cell 30. Gamma-ray emission rates are about 1000-fold higher than those of neutrons for many materials of interest. Therefore, the ability to differentiate neutrons from gamma photons can be crucial in certain applications. The ionizing radiation associated with the neutron capture of high neutron cross-section elements in the presence of water produces H₂O₂ in an amount directly proportional to the Linear Energy Transfer or about 1E4 hydrogen peroxide molecules per 1 MeV. Depending on the neutron target isotope, between 2E4 (10B) and 1.5E6 (235U) hydrogen peroxide molecules are produced per neutron capture event. Gamma-rays radiolysis of water also produces hydrogen peroxide, but at much lower rate. The linear attenuation coefficient of gamma rays in water is 0.136 cm-1 at 200 keV. Full attenuation of a gamma photon with water is much less probable than that of ionizing radiation. Furthermore, a fully attenuated gamma photon will generate fewer than 900 hydrogen peroxide molecules. Therefore, the apparatus, consisting of low Z elements (where Z is no greater than 8) and with a thickness of about 1 to about 10 μm, will provide gamma rejection rates between 99.99% and 99.999%. However, the effective or actual gamma rejection rate for the apparatus 10 should be much greater than 99.999%. This rate is realized when the efficiency for hydrogen peroxide generation is compared between neutron capture-induced ionizing radiation and gamma-ray attenuation. This rate of gamma rejection minimizes and/or eliminates the possibility of false positives from innocuous background sources of gamma radiation, such as food irradiators, medical and radiography sources, and medical patients.

Beyond this inherent means of discrimination, which is likely to be more than sufficient, further differentiation may also be possible. First, the use of thin cells 18 and 30 in the apparatus 10 can increase gamma rejection. Further the apparatus 10 can utilize the reference cell 30 to compensate for hydrogen peroxide formation caused by gamma-ray radiolysis. Specifically, the reference cell 30, which may be liquid or solid polymer gel, is formulated without the high barns isotope. Instead, the reference cell 30 is provided with water 32 alone and serves as a reference for the cell 18, which can be called the detection cell. As a result, the amount of hydrogen peroxide caused by gamma-ray radiolysis can be observed and measured in the reference cell 30. Then this measurement can be subtracted from the detection cell 18 during interrogation to result in the amount of hydrogen peroxide caused by neutron capture.

In FIG. 3, the detection cell 18 and the reference cell 30 are illustrated as being formed in an integral housing 20. As stated above, the housing 20 may be optional depending on the phase of the cells 18 and 30. In any event, in the exemplary embodiment, the reference cell 30 is positioned between the detection cell 18 and the area to be monitored so that any neutrons reaching the detection cell 18 have passed through the reference cell 30. This provides for additional moderation of the neutrons by the water, i.e., the water slows the neutrons. Further, the use of heavy water, deuterium oxide (D₂O), as the water component of cells 18 and 30 can further moderate (slow) the neutrons.

In selecting the source of the high barns isotope, a driving consideration is the thickness of the cell layer required for neutron capture. As stated above, thin layers facilitate gamma rejection. The natural abundance of ¹⁰B is 20%, and it has a thermal neutron cross section of 3840 barns. A solution, solid polymer gel or a nanocomposite system containing 50 wt. % of a typical unenriched carborane or borane would contain about 4.6E21 ¹⁰B nuclei per cubic centimeter. Assuming monoenergetic neutrons at 0.025 eV, an approximate 1.3 millimeter (mm) layer of solution or material would capture about 90% of all incident thermal neutrons. If the carborane and/or borane was enriched in ¹⁰B, the thickness can be decreased to about 0.25 mm.

The natural abundance of ⁶Li is 7.5% with a thermal neutron cross section of 940 barns. A similar material containing 50 wt. % of unenriched ⁶Li would contain about 1.7E21 ⁶Li nuclei per cubic centimeter and would need to be about 14 mm thick to stop 90% of incident monoenergetic thermal neutrons. An enriched version of the same material would need to be about 1.0 mm thick or about four times thicker than the equivalent ¹⁰B containing material.

The tables below further disclose the approximate thicknesses of the detecting cell in the apparatus to capture desired percentages of neutrons.

| Approximate wt. % | | | | | | | | | | |
|---|---|---|---|---|---|---|---|---|---|---|
| ¹⁰B (unenriched) | 10 | 20 | 30 | 40 | 50 | 60 | 70 | 80 | 90 | 100 |
| Approximate | 9.20E+20 | 1.84E+21 | 2.76E+21 | 3.68E+21 | 4.60E+21 | 5.52E+21 | 6.44E+21 | 7.36E+21 | 8.28E+21 | 9.20E+21 |
| number of ¹⁰B nuclei | | | | | | | | | | |
| Minimum layer | 6.52 mm | 3.26 mm | 2.17 mm | 1.63 mm | 1.30 mm | 1.09 mm | 0.93 mm | 0.81 mm | 0.72 mm | 0.65 mm |
| thickness to stop | | | | | | | | | | |
| 90% of neutrons | | | | | | | | | | |
| (unenriched) | | | | | | | | | | |
| Minimum layer | 1.25 mm | 0.63 mm | 0.42 mm | 0.31 mm | 0.25 mm | 0.21 mm | 0.18 mm | 0.16 mm | 0.14 mm | 0.13 mm |
| thickness to stop | | | | | | | | | | |
| 90% of neutrons | | | | | | | | | | |
| (enriched) | | | | | | | | | | |
| Approximate wt. % | | | | | | | | | | |
| ⁶Li (unenriched) | 10 | 20 | 30 | 40 | 50 | 60 | 70 | 80 | 90 | 100 |
| Approximate | 3.40E+20 | 6.80E+20 | 1.02E+21 | 1.36E+21 | 1.70E+21 | 2.04E+21 | 2.38E+21 | 2.72E+21 | 3.06E+21 | 3.40E+21 |
| number of ⁶Li nuclei | | | | | | | | | | |
| Minimum layer | 72.05 mm | 36.02 mm | 24.02 mm | 18.01 mm | 14.41 mm | 12.01 mm | 10.29 mm | 9.01 mm | 8.01 mm | 7.20 mm |
| thickness to stop | | | | | | | | | | |
| 90% of neutrons | | | | | | | | | | |
| (unenriched) | | | | | | | | | | |
| Minimum layer | 5.40 mm | 2.70 mm | 1.80 mm | 1.35 mm | 1.08 mm | 0.90 mm | 0.77 mm | 0.68 mm | 0.60 mm | 0.54 mm |
| thickness to stop | | | | | | | | | | |
| 90% of neutrons | | | | | | | | | | |
| (enriched) | | | | | | | | | | |

While it is important that the source of the high barns isotope be water soluble, the source may be selected from a wide variety of options. For example, the source may be one of the water soluble borane or carborane cage compounds identified in U.S. application Ser. Nos. 12/816,555 or 12/859,658 which are incorporated herein by reference.

The dodecaborane ions or borane salts ([closo-B₁₂H₁₂]²⁻) are water soluble. For example, [Li]₂[B₁₂H₁₂] is highly soluble in water and is 92.2 wt % boron and lithium. In certain embodiments, lithium salts of the boranes would be preferred over other counterions. Boron cage compounds offer a number of attractive qualities, but a wide variety of simple boron containing compounds, for example boric acid (B(OH)₃) which is 17.5% boron, may also be used as the source of the high barns isotope.

Regarding the dimensions of the apparatus 10, several factors may be considered. A typical shipping container is about 6 m to about 12 m by about 2.5 m by about 2.5 m. For a cell having an area of only 2.5 cm2 (orthogonal to the neutron source), which is positioned 2.5 m from a 50 kg source of HEU, about 1E9 neutrons would be integrated over twelve days. For 50 kg of plutonium, 1E13 neutrons would be integrated over 12 days.

Therefore, a 2.5 cm2 disk-shaped cell with 50 wt % unenriched 10B and a thickness of about 1.3 mm would capture 90% of the 1E9 neutrons integrated over 12 days, if it was at a distance of 2.5 m from 50 kg of HEU. The total number of hydrogen peroxide molecules generated (given sufficient water) would be 2.25E13 hydrogen peroxide molecules (2.5E4×1E9=2.5E13×90%) The radius of a 2.5 cm2 circle is about 0.892 cm. Increasing the radius of the circle to 10 cm would result in 7.07E15 hydrogen peroxide molecules generated, keeping everything else proportional. Likewise, a disk-shaped cell with a radius of 100 cm would produce about 1.08 mmoles of hydrogen peroxide.

For the present apparatus, cells formed from liquid or solid polymer or gel systems are envisioned. Clear, light transmissible liquid systems would be relatively easy to formulate, could be easily scaled-up in size/volume, and could easily be pumped, circulated, injected, and/or extracted. Liquids are also easily made into controllably thin layers.

On the continuum between liquid and solid systems, it may be possible to engineer solid materials that are either highly saturated with the desired, water-based, liquid system or are outright gels. An exemplary cell formed of solid gel must meet the critical criteria of intimate contact and physical mobility between the water and the source of high barns isotope. Further, cells formed from solid gel provide the ability to shape the apparatus into lenses, light guides, and the like.

Clear, light transmissible, solid polymer gel systems would have the simple advantages of not requiring containment and associated optic barriers, and could potentially be shaped into a lens or even fiber optic cables. As with liquids, solid systems without 10B and/or 6Li could also serve as a reference material with almost no thermal neutron sensitivity. Both liquid and solid systems, requiring water to function properly, would not suffer from moisture susceptibility. Although water is required, relatively broad useable temperature ranges are likely, because of the freezing point suppression expected from properly formulated mixtures.

In order to operate correctly, the solid embodiment cell should be clear. The basic polymeric material used in soft contact lenses, HEMA-based hydrogels are optically clear and colorless, easily swollen with salt containing water, structurally sound, and easily molded into specific desired shapes, including thin layers. Hydrogels based on 2-hydroxyethyl methacrylate (HEMA) and related materials and their synthesis could be used. By employing photopolymerization techniques, monolithic solids, as well as thin layers or coatings can be produced conveniently and rapidly.

These systems allow for altering properties of the hydrogels by varying the chemical composition. Monomers can be incorporated that are neutral or ionizable, and the crosslinker content can be varied, thus controlling the degree of hydrogel swelling. These variables allow for a highly tunable system.

In a method of fabricating the apparatus 10, the cell 18 is first configured to hold the water 26. The source of the high barns isotope configured to absorb neutrons is inserted or formed into the cell. As stated above, neutron absorption by the high barns isotope in the presence of the water causes the formation of H₂O₂. And the presence of H₂O₂ in the cell indicates exposure of the cell to neutrons.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A neutron detection apparatus comprising:
a cell configured to hold water; and
a source of at least one high barns isotope positioned in the cell and configured to absorb neutrons, wherein neutron absorption by the high barns isotope in the presence of water causes the formation of H₂O₂, and wherein the presence of H₂O₂ in the cell indicates exposure of the cell to neutrons.

2. The neutron detection apparatus of claim 1 wherein the high barns isotope is selected from the group comprising ¹⁰B, ⁶Li, ¹⁵⁷Gd, and ²³⁵U.

3. The neutron detection apparatus of claim 1 wherein the high barns isotope is ¹⁰B, and wherein the source is boric acid.

4. The neutron detection apparatus of claim 1 wherein the high barns isotope is ¹⁰B, and wherein the source is a boron cage compound.

5. The neutron detection apparatus of claim 1 wherein the high barns isotope is ¹⁰B, and wherein the source is borane salts.

6. The neutron detection apparatus of claim 1 wherein the source is water soluble, and wherein water and the source form a substantially homogenous mixture.

7. The neutron detection apparatus of claim 1 wherein the water is deuterium oxide (²H₂O).

8. The neutron detection apparatus of claim 1 wherein the cell is a detection cell, wherein water in the detection cell is configured to form H₂O₂ as a result of gamma-ray radiolysis, and wherein the apparatus further comprises:
a reference cell configured to hold water and positioned adjacent to the detection cell;
wherein the reference cell is configured to provide a reference amount of H₂O₂ formation resulting from gamma-ray radiolysis for comparison to H₂O₂ formation in the detection cell.

9. The neutron detection apparatus of claim 8 wherein the apparatus has a front side for receiving neutrons and a rear side, wherein the detection cell is proximate to the rear side, and wherein the reference cell is proximate to the front side and is configured to moderate neutrons as neutrons pass through the reference cell before being absorbed by the high barns element in the detection cell.

10. A neutron detection apparatus having a non-exposed state and a neutron exposed state, the neutron detection apparatus in the non-exposed state comprising:
water; and
a source of at least one high barns isotope mixed with the water and configured to absorb neutrons, wherein the apparatus is configured to transform to the neutron exposed state when the high barns isotope absorbs neutrons and H₂O₂ is formed.

11. The neutron detection apparatus of claim 10 wherein the high barns isotope is selected from the group comprising ¹⁰B, ⁶Li, ¹⁵⁷Gd, and ²³⁵U.

12. The neutron detection apparatus of claim 10 wherein the high barns isotope is ¹⁰B, and wherein the source is boric acid.

13. The neutron detection apparatus of claim 10 wherein the high barns isotope is ¹⁰B, and wherein the source is a boron cage compound.

14. The neutron detection apparatus of claim 10 wherein the high barns isotope is ¹⁰B, and wherein the source is borane salts.

15. The neutron detection apparatus of claim 10 wherein the source is water soluble, and wherein the water and the source form a substantially homogenous mixture.

16. The neutron detection apparatus of claim 10 wherein the water is deuterium oxide (²H₂O).

17. The neutron detection apparatus of claim 10 wherein the water and the source form a detection cell, wherein the water in the detection cell is configured to form H₂O₂ as a result of gamma-ray radiolysis, and wherein the apparatus further comprises:
a reference cell positioned adjacent to the detection cell;
water positioned in the reference cell for providing a reference amount of H₂O₂ formation resulting from gamma-ray radiolysis for comparison to H₂O₂ formation in the detection cell.

18. The neutron detection apparatus of claim 17 wherein the apparatus has a front side for receiving neutrons and a rear side, wherein the detection cell is proximate to the rear side, and wherein the reference cell is proximate to the front side to moderate neutrons as neutrons pass through the reference cell before being absorbed by the high barns element in the detection cell.

19. A method for fabricating a neutron detection apparatus, the method comprising the steps of:
providing a cell configured to hold water;
inserting a source of at least one high barns isotope configured to absorb neutrons into the cell, wherein neutron absorption by the high barns isotope in the presence of the water causes the formation of H₂O₂, and wherein the presence of H₂O₂ in the cell indicates exposure of the cell to neutrons.

20. The method of claim 19 wherein the step of inserting comprises inserting a source of high barns isotope selected from the group consisting of ¹⁰B, ⁶Li, ¹⁵⁷Gd, and ²³⁵U.
